(19) United States
(12) Patent Application Publication
(10) Pub. No.: US 2018/0310210 A1
(43) Pub. Date: Oct. 25, 2018

(54) METHOD AND APPARATUS FOR SUPPORTING FAST HANDOVER IN WIRELESS COMMUNICATION SYSTEM

(71) Applicant: LG ELECTRONICS INC., Seoul (KR)

(72) Inventors: Yunjung Yi, Seoul (KR); Hanbyul Seo, Seoul (KR); Sunyoung Lee, Seoul (KR)

(21) Appl. No.: 15/765,966

(22) PCT Filed: Oct. 21, 2016
(86) PCT No.: PCT/KR2016/011911

§ 371 Date: Apr. 4, 2018

Related U.S. Application Data
(60) Provisional application No. 62/244,721, filed on Oct. 21, 2015.

(51) Int. Cl. H04W 36/00; H04W 36/26; H04W 52/40; H04W 52/22; H04W 52/50

(52) U.S. Cl. CPC H04W 36/0077; H04W 36/0061; H04W 36/0072; H04W 52/362; H04W 52/40; H04W 52/228; H04W 52/50; H04W 36/26

(57) ABSTRACT

A method and apparatus for performing a handover procedure from a source cell to a target cell in a wireless communication system is provided. A user equipment (UE) receives a configuration indicating that a random access procedure towards a target cell is not to be performed from a network, and determines at least one of transmission power or timing advance (TA) for the target cell.

### CROSS-REFERENCE TO RELATED APPLICATIONS

This application is the National Stage filing under 35 U.S.C. 371 of International Application No. PCT/KR2016/011911, filed on Oct. 21, 2016, which claims the benefit of U.S. Provisional Application No. 62/244,721 filed on Oct. 21, 2015, the contents of which are all hereby incorporated by reference herein in their entirety.

### BACKGROUND OF THE INVENTION

### Field of the Invention

The present invention relates to wireless communications, and more particularly, to a method and apparatus for performing a fast handover in a wireless communication system.

### Related Art

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Small cells using low power nodes are considered promising to cope with mobile traffic explosion, especially for hotspot deployments in indoor and outdoor scenarios. A low-power node generally means a node whose transmission power is lower than macro node and base station (BS) classes, for example pico and femto evolved NodeB (eNB) are both applicable. Small cell enhancements for evolved UMTS terrestrial radio access (E-UTRA) and evolved UMTS terrestrial radio access network (E-UTRAN) will focus on additional functionalities for enhanced performance in hotspot areas for indoor and outdoor using low power nodes.

In 3GPP LTE, there are multiple components contributing to the total end to end delay for connected user equipments (UEs). The limitations in performance are in general use case dependent, for which, e.g. UL latency may influence the DL application performance and vice versa. One of examples of sources to latency is a random access procedure. If the UL timing of a UE is not aligned, initial time alignment is acquired with the random access procedure. The time alignment can be maintained with timing advance commands from the eNB to the UE. However, it may be desirable to stop the maintenance of UL time alignment after a period of inactivity, thus the duration of the random access procedure may contribute to the overall latency in radio resource control (RRC) connected mode. The random access procedure also serves as an uplink (UL) grant acquisition mechanism (random access based scheduling request).

The random access procedure may cause significant latency for handover procedure when a lot of small cells are deployed. Accordingly, a fast handover procedure in order to avoid latency may be required.

### SUMMARY OF THE INVENTION

The present invention provides a method and apparatus for performing a fast handover in a wireless communication system. The present invention discusses mechanisms to support a fast handover procedure, particularly, to avoid a random access channel (RACH) procedure.

In an aspect, a method for performing a handover procedure from a source cell to a target cell by a user equipment (UE) in a wireless communication system is provided. The method includes receiving a configuration indicating that a random access procedure towards a target cell is not to be performed from a network, and determining at least one of transmission power or timing advance (TA) for the target cell.

In another aspect, a user equipment (UE) in a wireless communication system is provided. The UE includes a memory, a transceiver, and a processor, coupled to the memory and the transceiver, that controls the transceiver to receive a configuration indicating that a random access procedure towards a target cell is not to be performed from a network, and determines at least one of transmission power or timing advance (TA) for the target cell.

A user equipment (UE) can be handed over from a source cell to a target cell relatively quickly, particularly by avoiding a random access procedure.

### BRIEF DESCRIPTION OF THE DRAWINGS

FIG. 1 shows a wireless communication system.

FIG. 2 shows structure of a radio frame of 3GPP LTE.

FIG. 3 shows a resource grid for one downlink slot.

FIG. 4 shows structure of a downlink subframe.

FIG. 5 shows structure of an uplink subframe.

FIG. 6 shows a contention based random access procedure.

FIG. 7 shows a method for performing a handover procedure from a source cell to a target cell by a UE according to an embodiment of the present invention.

FIG. 8 shows a wireless communication system to implement an embodiment of the present invention.

### DESCRIPTION OF EXEMPLARY EMBODIMENTS

Techniques, apparatus and systems described herein may be used in various wireless access technologies such as code division multiple access (CDMA), frequency division multiple access (FDMA), time division multiple access (TDMA), orthogonal frequency division multiple access (OFDMA), single carrier frequency division multiple access (SC-FDMA), etc. The CDMA may be implemented with a radio technology such as universal terrestrial radio access (UTRA) or CDMA2000. The TDMA may be implemented with a radio technology such as global system for mobile communications (GSM)/general packet radio service (GPRS)/enhanced data rates for GSM evolution (EDGE). The OFDMA may be implemented with a radio technology such as institute of electrical and electronics engineers (IEEE) 802.11 (Wi-Fi), IEEE 802.16 (WiMAX), IEEE 802-20, evolved-UTRA (E-UTRA) etc. The UTRA is a part of a universal mobile telecommunication system (UMTS). 3rd generation partnership project (3GPP) long term evolution (LTE) is a part of an evolved-UMTS (E-UMTS) using the E-UTRA. The 3GPP LTE employs the OFDMA in downlink (DL) and employs the SC-FDMA in uplink (UL). LTE-advance (LTE-A) is an evolution of the 3GPP LTE. For clarity, this application focuses on the 3GPP LTE/LTE-A. However, technical features of the present invention are not limited thereto.

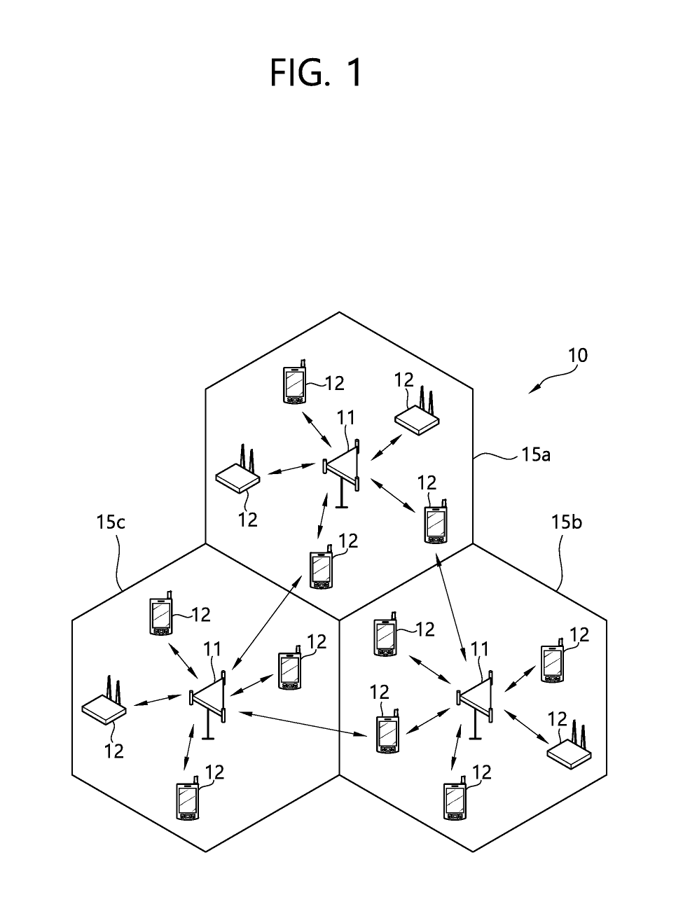

FIG. 1 shows a wireless communication system. The wireless communication system 10 includes at least one evolved NodeB (eNB) 11. Respective eNBs 11 provide a communication service to particular geographical areas 15a, 15b, and 15c (which are generally called cells). Each cell may be divided into a plurality of areas (which are called sectors). A user equipment (UE) 12 may be fixed or mobile and may be referred to by other names such as mobile station (MS), mobile terminal (MT), user terminal (UT), subscriber station (SS), wireless device, personal digital assistant (PDA), wireless modem, handheld device. The eNB 11 generally refers to a fixed station that communicates with the UE 12 and may be called by other names such as base station (BS), base transceiver system (BTS), access point (AP), etc.

In general, a UE belongs to one cell, and the cell to which a UE belongs is called a serving cell. An eNB providing a communication service to the serving cell is called a serving eNB. The wireless communication system is a cellular system, so a different cell adjacent to the serving cell exists. The different cell adjacent to the serving cell is called a neighbor cell. An eNB providing a communication service to the neighbor cell is called a neighbor eNB. The serving cell and the neighbor cell are relatively determined based on a UE.

This technique can be used for DL or UL. In general, DL refers to communication from the eNB 11 to the UE 12, and UL refers to communication from the UE 12 to the eNB 11. In DL, a transmitter may be part of the eNB 11 and a receiver may be part of the UE 12. In UL, a transmitter may be part of the UE 12 and a receiver may be part of the eNB 11.

The wireless communication system may be any one of a multiple-input multiple-output (MIMO) system, a multiple-input single-output (MISO) system, a single-input single-output (SISO) system, and a single-input multiple-output (SIMO) system. The MIMO system uses a plurality of transmission antennas and a plurality of reception antennas. The MISO system uses a plurality of transmission antennas and a single reception antenna. The SISO system uses a single transmission antenna and a single reception antenna. The SIMO system uses a single transmission antenna and a plurality of reception antennas. Hereinafter, a transmission antenna refers to a physical or logical antenna used for transmitting a signal or a stream, and a reception antenna refers to a physical or logical antenna used for receiving a signal or a stream.

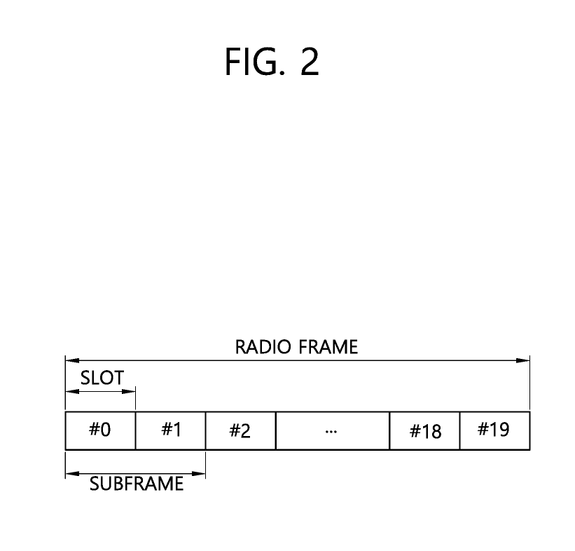

FIG. 2 shows structure of a radio frame of 3GPP LTE. Referring to FIG. 2, a radio frame includes 10 subframes. A subframe includes two slots in time domain. A time for transmitting one subframe is defined as a transmission time interval (TTI). For example, one subframe may have a length of 1 ms, and one slot may have a length of 0.5 ms. One slot includes a plurality of orthogonal frequency division multiplexing (OFDM) symbols in time domain. Since the 3GPP LTE uses the OFDMA in the DL, the OFDM symbol is for representing one symbol period. The OFDM symbols may be called by other names depending on a multiple-access scheme. For example, when SC-FDMA is in use as a UL multi-access scheme, the OFDM symbols may be called SC-FDMA symbols. A resource block (RB) is a resource allocation unit, and includes a plurality of contiguous subcarriers in one slot. The structure of the radio frame is shown for exemplary purposes only. Thus, the number of subframes included in the radio frame or the number of slots included in the subframe or the number of OFDM symbols included in the slot may be modified in various manners.

The wireless communication system may be divided into a frequency division duplex (FDD) scheme and a time division duplex (TDD) scheme. According to the FDD scheme, UL transmission and DL transmission are made at different frequency bands. According to the TDD scheme, UL transmission and DL transmission are made during different periods of time at the same frequency band. A channel response of the TDD scheme is substantially reciprocal. This means that a DL channel response and a UL channel response are almost the same in a given frequency band. Thus, the TDD-based wireless communication system is advantageous in that the DL channel response can be obtained from the UL channel response. In the TDD scheme, the entire frequency band is time-divided for UL and DL transmissions, so a DL transmission by the eNB and a UL transmission by the UE cannot be simultaneously performed. In a TDD system in which a UL transmission and a DL transmission are discriminated in units of subframes, the UL transmission and the DL transmission are performed in different subframes.

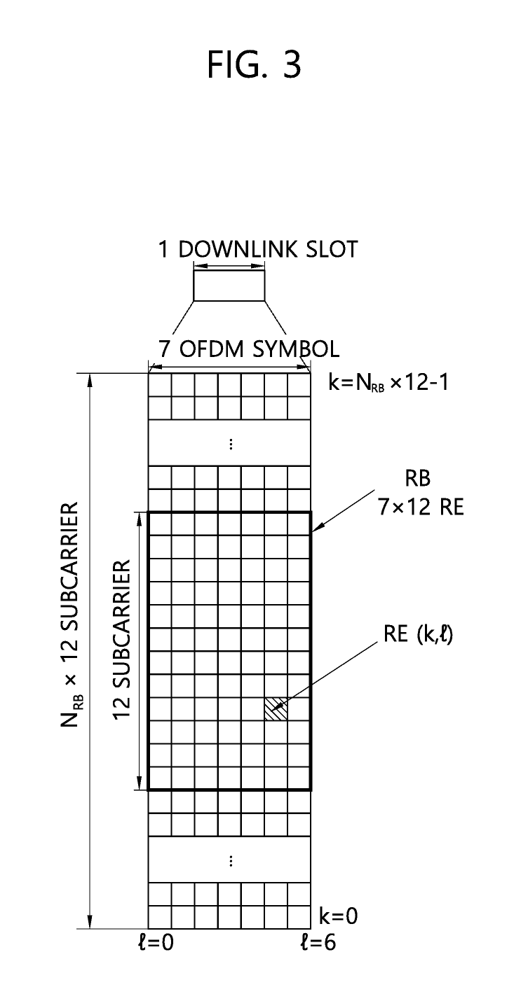

FIG. 3 shows a resource grid for one downlink slot. Referring to FIG. 3, a DL slot includes a plurality of OFDM symbols in time domain. It is described herein that one DL slot includes 7 OFDM symbols, and one RB includes 12 subcarriers in frequency domain as an example. However, the present invention is not limited thereto. Each element on the resource grid is referred to as a resource element (RE). One RB includes 12×7 resource elements. The number N^{DL} of RBs included in the DL slot depends on a DL transmit bandwidth. The structure of a UL slot may be same as that of the DL slot. The number of OFDM symbols and the number of subcarriers may vary depending on the length of a CP, frequency spacing, etc. For example, in case of a normal cyclic prefix (CP), the number of OFDM symbols is 7, and in case of an extended CP, the number of OFDM symbols is 6. One of 128, 256, 512, 1024, 1536, and 2048 may be selectively used as the number of subcarriers in one OFDM symbol.

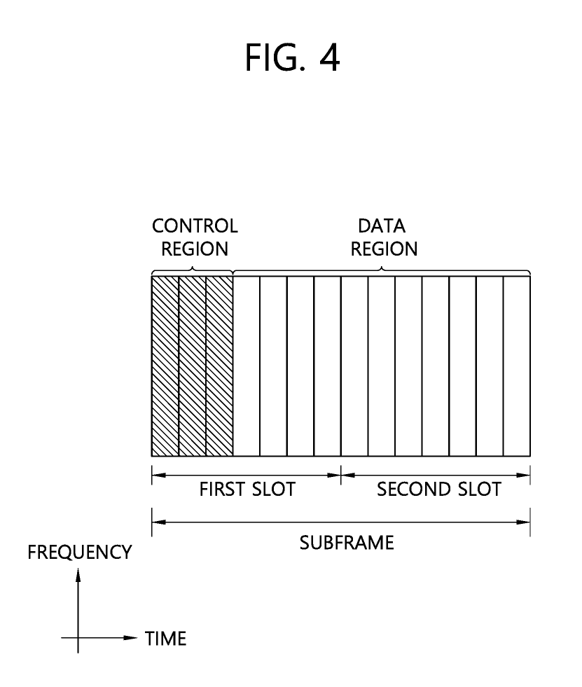

FIG. 4 shows structure of a downlink subframe. Referring to FIG. 4, a maximum of three OFDM symbols located in a front portion of a first slot within a subframe correspond to a control region to be assigned with a control channel. The remaining OFDM symbols correspond to a data region to be assigned with a physical downlink shared chancel (PDSCH). Examples of DL control channels used in the 3GPP LTE includes a physical control format indicator channel (PCFICH), a physical downlink control channel (PDCCH), a physical hybrid automatic repeat request (HARQ) indicator channel (PHICH), etc. The PCFICH is transmitted at a first OFDM symbol of a subframe and carries information regarding the number of OFDM symbols used for transmission of control channels within the subframe. The PHICH is a response of UL transmission and carries a HARQ acknowledgment (ACK)/non-acknowledgment (NACK) signal. Control information transmitted through the PDCCH is referred to as downlink control information (DCI). The DCI includes UL or DL scheduling information or includes a UL transmit (TX) power control command for arbitrary UE groups.

The PDCCH may carry a transport format and a resource allocation of a downlink shared channel (DL-SCH), resource allocation information of an uplink shared channel (UL-SCH), paging information on a paging channel (PCH), system information on the DL-SCH, a resource allocation of an upper-layer control message such as a random access response transmitted on the PDSCH, a set of TX power control commands on individual UEs within an arbitrary UE group, a TX power control command, activation of a voice over IP (VoIP), etc. A plurality of PDCCHs can be transmitted within a control region. The UE can monitor the plurality of PDCCHs. The PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups.

A format of the PDCCH and the number of bits of the available PDCCH are determined according to a correlation between the number of CCEs and the coding rate provided by the CCEs. The eNB determines a PDCCH format according to a DCI to be transmitted to the UE, and attaches a cyclic redundancy check (CRC) to control information. The CRC is scrambled with a unique identifier (referred to as a radio network temporary identifier (RNTI)) according to an owner or usage of the PDCCH. If the PDCCH is for a specific UE, a unique identifier (e.g., cell-RNTI (C-RNTI)) of the UE may be scrambled to the CRC. Alternatively, if the PDCCH is for a paging message, a paging indicator identifier (e.g., paging-RNTI (P-RNTI)) may be scrambled to the CRC. If the PDCCH is for system information (more specifically, a system information block (SIB) to be described below), a system information identifier and a system information RNTI (SI-RNTI) may be scrambled to the CRC. To indicate a random access response that is a response for transmission of a random access preamble of the UE, a random access-RNTI (RA-RNTI) may be scrambled to the CRC.

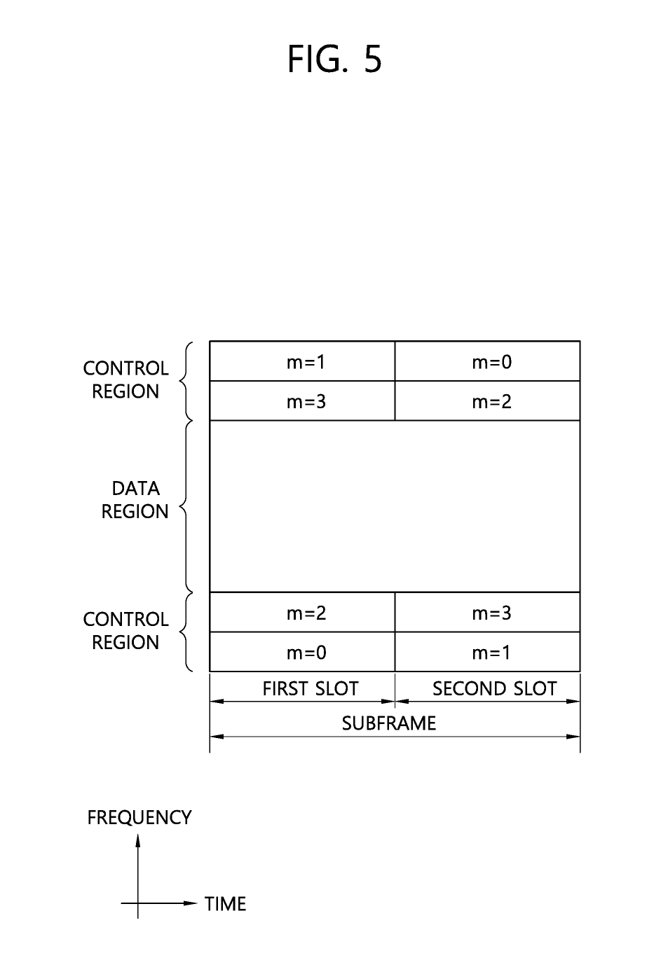

FIG. 5 shows structure of an uplink subframe. Referring to FIG. 5, a UL subframe can be divided in a frequency domain into a control region and a data region. The control region is allocated with a physical uplink control channel (PUCCH) for carrying UL control information. The data region is allocated with a physical uplink shared channel (PUSCH) for carrying user data. When indicated by a higher layer, the UE may support a simultaneous transmission of the PUSCH and the PUCCH. The PUCCH for one UE is allocated to an RB pair in a subframe. RBs belonging to the RB pair occupy different subcarriers in respective two slots. This is called that the RB pair allocated to the PUCCH is frequency-hopped in a slot boundary. This is said that the pair of RBs allocated to the PUCCH is frequency-hopped at the slot boundary. The UE can obtain a frequency diversity gain by transmitting UL control information through different subcarriers according to time.

UL control information transmitted on the PUCCH may include a HARQ ACK/NACK, a channel quality indicator (CQI) indicating the state of a DL channel, a scheduling request (SR), and the like. The PUSCH is mapped to a UL-SCH, a transport channel. UL data transmitted on the PUSCH may be a transport block, a data block for the UL-SCH transmitted during the TTI. The transport block may be user information. Or, the UL data may be multiplexed data. The multiplexed data may be data obtained by multiplexing the transport block for the UL-SCH and control information. For example, control information multiplexed to data may include a CQI, a precoding matrix indicator (PMI), an HARQ, a rank indicator (RI), or the like. Or the UL data may include only control information.

Random access procedure is described. It may be referred to as Section 10.1.5 of 3GPP TS 36.300 V13.1.0 (September 2015) and Section 5.1 of 3GPP TS 36.321 V12.7.0 (September 2015). The random access procedure is performed for the following events related to the primary cell (PCell):
Initial access from RRC_IDLE;
RRC connection re-establishment procedure;
Handover;
DL data arrival during RRC_CONNECTED requiring random access procedure (e.g. when UL synchronization status is “non-synchronized”);
UL data arrival during RRC_CONNECTED requiring random access procedure (e.g. when UL synchronization status is “non-synchronized” or there are no PUCCH resources for scheduling request (SR) available);
For positioning purpose during RRC_CONNECTED requiring random access procedure (e.g. when timing advance is needed for UE positioning).

The random access procedure is also performed on a secondary cell (SCell) to establish time alignment for the corresponding secondary timing advance group (sTAG).

In dual connectivity, the random access procedure is also performed on at least primary SCell (PSCell) upon secondary cell group (SCG) addition/modification, if instructed, or upon DL/UL data arrival during RRC_CONNECTED requiring random access procedure. The UE initiated random access procedure is performed only on PSCell for SCG.

Furthermore, the random access procedure takes two distinct forms:
Contention based (applicable to first five events);
Non-contention based (applicable to only handover, DL data arrival, positioning and obtaining timing advance alignment for a sTAG).

Normal DL/UL transmission can take place after the random access procedure.

The random access procedure is initiated by a PDCCH order, by the media access control (MAC) sublayer itself or by the RRC sublayer. Random access procedure on a SCell shall only be initiated by a PDCCH order. If a MAC entity receives a PDCCH transmission consistent with a PDCCH order masked with its C-RNTI, and for a specific serving cell, the MAC entity shall initiate a random access procedure on this serving cell. For random access on the special cell (SpCell) a PDCCH order or RRC optionally indicate the ra-PreambleIndex and the ra-PRACH-MaskIndex; and for random access on a SCell, the PDCCH order indicates the ra-PreambleIndex with a value different from 000000 and the ra-PRACH-MaskIndex. For the pTAG preamble transmission on physical random access channel (PRACH) and reception of a PDCCH order are only supported for SpCell.

The random access procedure shall be performed as follows:
Flush the Msg3 buffer;
set the PREAMBLE_TRANSMISSION_COUNTER to 1;
set the backoff parameter value to 0 ms;
proceed to the selection of the random access resource.

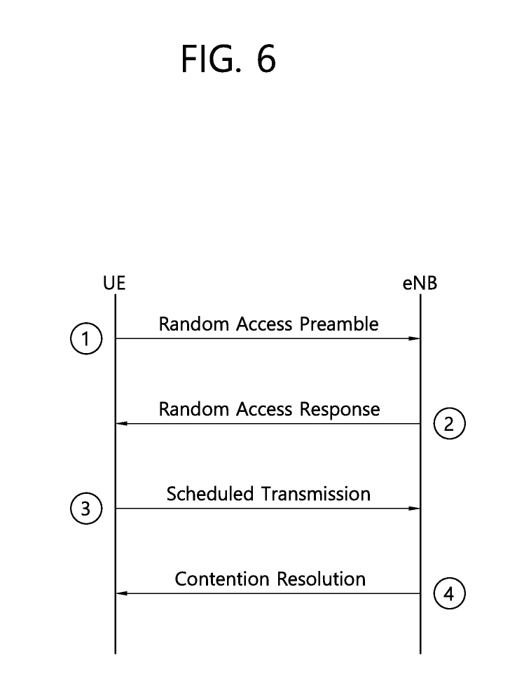

FIG. 6 shows a contention based random access procedure. The four steps of the contention based random access procedures are as follows:

(1) Random access preamble on random access channel (RACH) in UL: The random access preamble may be called as different names, i.e. preamble, PRACH preamble or message 1 (Msg 1).

The random access preamble may be selected randomly by a UE for the contention based random access procedure. The power for the random access preamble may be selected based on eNB configuration of target received threshold and received power at the UE. Specifically, the random access preamble may be transmitted as follows.
set PREAMBLE_RECEIVED_TARGET_POWER to preambleInitialReceivedTargetPower+DELTA_PREAMBLE+(PREAMBLE_TRANSMISSION_COUNTER−1)*powerRampingStep;
instruct the physical layer to transmit a preamble using the selected PRACH, corresponding RA-RNTI, preamble index and PREAMBLE_RECEIVED_TARGET_POWER.

(2) Random access response (RAR) generated by MAC on DL-SCH: The RAR may be called as different names, i.e. message 2 (Msg 2). For the successful PRACH reception, RAR is transmitted which includes UL grant for message 3. In case of non-contention based random access procedure, the RAR may include contention resolution message.

Once the random access preamble is transmitted and regardless of the possible occurrence of a measurement gap, the MAC entity shall monitor the PDCCH of the SpCell for RAR(s) identified by the RA-RNTI defined below, in the RA response window which starts at the subframe that contains the end of the preamble transmission plus three subframes and has length ra-ResponseWindowSize subframes. The RA-RNTI associated with the PRACH in which the random access rreamble is transmitted, is computed as: RA-RNTI=1+t_id+10*f_id, where t_id is the index of the first subframe of the specified PRACH (0≤t_id<10), and f_id is the index of the specified PRACH within that subframe, in ascending order of frequency domain (0≤f_id<6). The MAC entity may stop monitoring for RAR(s) after successful reception of a RAR containing random access preamble identifiers that matches the transmitted random access preamble.

1> If a DL assignment for this TTI has been received on the PDCCH for the RA-RNTI and the received transport block (TB) is successfully decoded, the MAC entity shall regardless of the possible occurrence of a measurement gap:

2> if the RAR contains a backoff indicator subheader:

3> set the backoff parameter value as indicated by the backoff indicator (BI) field of the backoff indicator subheader.

2> else, set the backoff parameter value to 0 ms.

2> if the RAR contains a random access preamble identifier corresponding to the transmitted random access preamble, the MAC entity shall:

3> consider this RAR reception successful and apply the following actions for the serving cell where the random access preamble was transmitted:

4> process the received timing advance command;

4> indicate the preambleInitialReceivedTargetPower and the amount of power ramping applied to the latest preamble transmission to lower layers (i.e., (PREAMBLE_TRANSMISSION_COUNTER−1)*powerRampingStep);

4> process the received UL grant value and indicate it to the lower layers;

3> if ra-PreambleIndex was explicitly signalled and it was not 000000 (i.e., not selected by MAC):

4> consider the random access procedure successfully completed.

3> else, if the random access preamble was selected by the MAC entity:

4> set the temporary C-RNTI to the value received in the RAR message no later than at the time of the first transmission corresponding to the UL grant provided in the RAR message;

4> if this is the first successfully received RAR within this random access procedure:

5> if the transmission is not being made for the common control channel (CCCH) logical channel, indicate to the multiplexing and assembly entity to include a C-RNTI MAC control element (CE) in the subsequent UL transmission;

5> obtain the MAC protocol data unit (PDU) to transmit from the multiplexing and assembly entity and store it in the Msg3 buffer.

If no RAR is received within the RA response window, or if none of all received RARs contains a random access preamble identifier corresponding to the transmitted random access preamble, the RAR reception is considered not successful and the MAC entity shall:

1> if the notification of power ramping suspension has not been received from lower layers:

2> increment PREAMBLE_TRANSMISSION_COUNTER by 1;

1> If PREAMBLE_TRANSMISSION_COUNTER=preambleTransMax+1:

2> if the random access preamble is transmitted on the SpCell:

3> indicate a random access problem to upper layers;

2> if the random access preamble is transmitted on an SCell:

3> consider the random access procedure unsuccessfully completed.

1> if in this random access procedure, the random access preamble was selected by MAC:

2> based on the backoff parameter, select a random backoff time according to a uniform distribution between 0 and the backoff parameter value;

2> delay the subsequent random access transmission by the backoff time;

1> proceed to the selection of a random access resource.

(3) First scheduled UL transmission on UL-SCH: The first scheduled UL transmission may be called as different names, i.e. message 3 (Msg 3). In case of non-contention based random access procedure, Msg 3 may be used to transmit UL data. Msg 3 is transmitted via PUSCH, and the UE transmit power P_{PUSCH,c}(i) for PUSCH transmission in subframe i for the serving cell c is given by Equation 1.

$$〈 Equation 1 〉$$

$${P}_{PUSCH , c} ( i ) = min \{ \begin{matrix}{P}_{CMAX , c} ( i ) , \\ \begin{matrix}10 {log}_{10} ( {M}_{PUSCH , o} ( i ) ) + {P}_{O\_PUSCH , c} ( j ) + \\ {α}_{c} ( j ) \cdot {PL}_{c} + {Δ}_{TF , c} ( i ) + {f}_{c} ( i )\end{matrix}\end{matrix} \} [ dBm ]$$

In Equation 1, P_{CMAX,c}(i) is the configured UE transmit power in subframe i for serving cell c. M_{PUSCH,c}(i) is the bandwidth of the PUSCH resource assignment expressed in number of resource blocks valid for subframe i and serving cell c. P_{O-PUSCH,c}(i) is a parameter composed of the sum of a component P_{O-NOMINAL}_{_}_{PUSCH,c}(j) provided from higher layers and a component P_{O}_{_}_{UE}_{_}_{PUSCH,c}(j) provided by higher layers for serving cell c. PLc is the DL path loss estimate calculated in the UE for serving cell c in dB and PLc=referenceSignalPower−higher layer filtered reference signal received power (RSRP), where referenceSignalPower is provided by higher layers. f_{c}(i) is the current PUSCH power control adjustment state for serving cell c.

(4) Contention resolution on DL: The contention resolution message may be called as different names, i.e. message 4 (Msg 4). Msg 4 may include contention resolution message in case of contention based random access procedure.

In a small cell scenario, particularly with high frequency, frequent handover may occur due to small cell range and relatively high mobility. In such cases, it may become important to minimize handover latency between two cells. There may be multiple ways to reduce handover latency, and one of simple solution to reduce handover latency may be to minimize or eliminate random access procedure occurred during handover procedure. By minimizing or eliminating random access procedure occurred during handover procedure, fast handover can be supported.

Hereinafter, a method for supporting a fast handover procedure according to an embodiment of the present invention is proposed. In order to reduce handover latency regarding random access procedure, one of the following options may be considered.

(1) The entire random access procedure may be eliminated. That is, the entire random access procedure is assumed not to be performed if the network configures not to perform random access procedure. In this case, from the UE configuration perspective, the necessary parameters may be configured by the source cell (which are forwarded by the target cell to the source cell) before handover procedure. The necessary parameters may include at least one of initial RRC configuration, initial value of transmit power command (TPC), and/or timing advance (TA) value.

For determining power and TA for UL transmission towards the target cell, specifically Msg 3, one of the following options may be considered.
The same power and TA used in source cell may be used as it is for power and TA for UL transmission towards the target cell.
Instead of using the same power, only parameter fc(i) (i.e. the accumulated TPC power from the source cell) may be inherited for determining power for UL transmission towards the target cell. That is, for determining power for UL transmission towards the target cell, parameters such as P_{O-PUSCH,c}(i), PLc, and other semi-statically configurable parameters may be given to the UE from the target cell, before receiving a handover command from the source cell. When a UE is configured to do so, the UE may inherit the accumulated TPC power from the source cell. The absolute TPC power may also be configured by the target cell via the source cell. Also, whether to inherit the same accumulated TPC power or not can be configured either by the target cell or source cell.
The source cell may configure offset on power and TA. The UE may determine the power and TA for UL transmission towards the target cell by using the offset.
The UE may determine power for UL transmission towards the target cell based on measurement. For determining power, initial PUSCH power may be computed assuming TPC=0. Or, a default value or default TPC power may be configured by the source cell.

(2) Instead of eliminating the entire random access procedure, a quick random access procedure based on non-contention based random access procedure may be performed. In this case, a UE may transmit UL data via Msg 3, thus latency can be reduced. In this option, power and TA may be adapted through RAR transmission.

In both options described above, when the source cell transmits either UL grant or PDCCH order for preamble transmission, the timing to transmit UL data should be determined. For simple approach, when the source cell transmits UL grant or PDCCH order, the source cell may also send the transmission timing, and a UE may initiate UL transmission at the configured timing. If there is no timing information configured, a UE may transmit UL data in subframe n+6, when UL grant is received in subframe n by the source cell via handover command. The timing may increase to allow higher layer data processing latency of handover command. For preamble transmission, the preamble may be transmitted at the first available PRACH resource at or after subframe n+8 since the handover command reception. Further, RNTI configured by the target cell may be used for UL data transmission. Also, for PRACH, PRACH configuration of the target cell may be used.

When UL grant is scheduled, the message format used for Msg 3 may be reused. In that UL grant, initial TPC value may also be included (or excluded). In the UL grant, some configuration parameters may not be included. In this case, zero may be used for the configuration parameter. Alternatively, default value may be used for the configuration parameter. Alternatively, the same value used for the configuration from the source cell may be used for the configuration parameter. Further, power control for Msg 3 may be used for the UL grant. More specifically, preambleInitialReceivedTargetPower and deltaPreambleMsg3 configured by target cell via SIB for TPC parameters assuming no power ramping for PRACH may be used for UL grant. In other words, as preamble has not been sent, preambleInitialReceivedTargetPower may be computed based on SIB configuration of the target cell and pathloss. Which option is used may also be configured. Further, different option may be used per configuration parameter.

Modulation and coding scheme (MCS) may also be configured by the network. When configuration is not given, a default MCS may be used.

If handover occurs from FDD source cell (or TDD source cell) to TDD target cell, default TA may be changed to 20 us. When TA is inherited or estimated, additional 20 us may be added to address TDD target cell.

Further, if random access procedure is eliminated and handover is performed from FDD source cell to TDD target cell, or from FDD source cell to FDD target cell, since it cannot be assumed that the cells are synchronized with each other, the timing difference measurement by the UE may not be performed. In this case, the timing offset may be indicated by the network or initial TA value may be forwarded by the target cell via the source cell. In other words, duplex of target cell may be known to the UE and the information may be used to determine TA difference. From TDD source cell to TDD target cell, if the frequency changes, it cannot be assumed that the network is synchronized. In general, either TA=0 in FDD target cell and TA=20 us in TDD target cell may be used if it is configured by the network to eliminate random access procedure.

Also, power or other parameters may be inherited from the source cell for the target cell or default parameters may be used in case of intra-frequency handover only. In other words, when the UE changes the frequency for the target cell, a UE may assume that random access procedure is always used. In this case, configuration of preamble resource (for non-contention based random access procedure) may be used.

In general, to minimize the handover latency, a UE may be requested by the source cell to read system information of the potential target cell before receiving handover command. This is particularly necessary if handover occurs to different frequency and/or between FDD cells.

Another approach to reduce handover latency is to initiate random access procedure even before receiving handover command. For this approach, a pre-handover command may be defined, and the UE may transmit preamble to the candidate target cell before receiving handover command. When random access procedure is completed, the UE may inform the successful handover to the source cell, and then the source cell may stop transmitting data/UL grant to the UE by transmitting handover command.

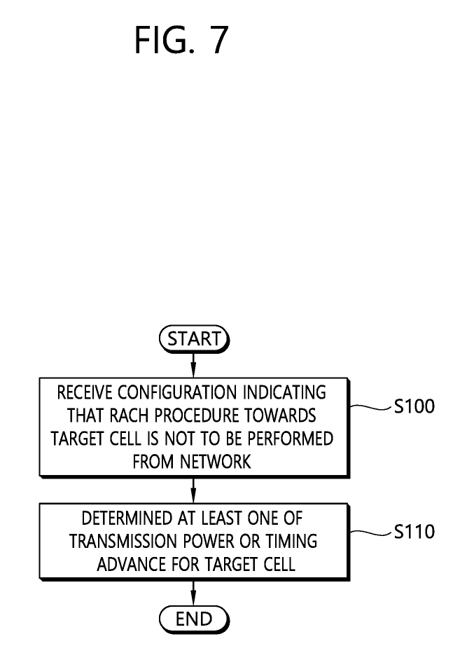

FIG. 7 shows a method for performing a handover procedure from a source cell to a target cell by a UE according to an embodiment of the present invention.

In step S100, the UE receives a configuration indicating that a random access procedure towards a target cell is not to be performed from a network. In step S110, the UE determines at least one of transmission power or TA for the target cell.

The transmission power for the target may be determined as the same transmission power used for the source cell. Alternatively, the transmission power for the target cell may be determined by using an accumulated TPC power used for the source cell. Alternatively, the transmission power for the target cell may be determined by using an offset from a transmission power used for the source cell. Alternatively, the transmission power for the target cell may be determined based on measurement.

The TA for the target cell may be determined as 0. Alternatively, the TA for the target cell may be determined as the same TA used for the source cell.

The UE may further receive a UL grant for transmission to the target cell from the target via the source cell. The transmission to the target cell may correspond to a message 3 in the random access procedure. A message format used for the message 3 may be reused. The power for the UL grant may be determined based on power control for the message 3.

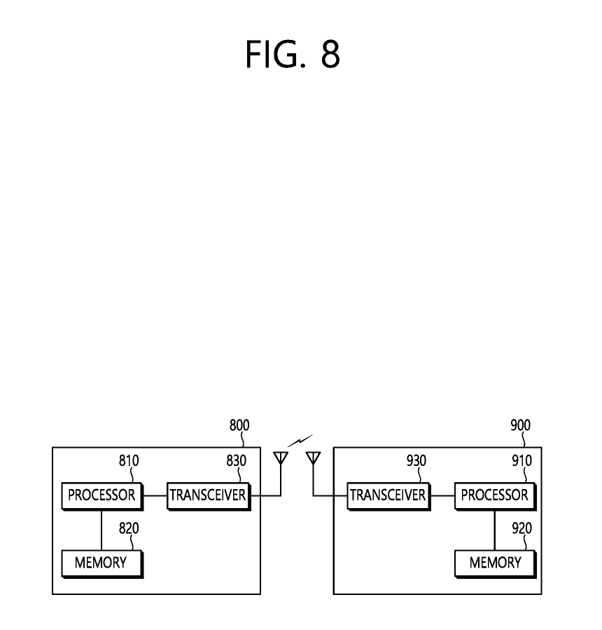

FIG. 8 shows a wireless communication system to implement an embodiment of the present invention.

An eNB 800 includes a processor 810, a memory 820 and a transceiver 830. The processor 810 may be configured to implement proposed functions, procedures and/or methods described in this description. Layers of the radio interface protocol may be implemented in the processor 810. The memory 820 is operatively coupled with the processor 810 and stores a variety of information to operate the processor 810. The transceiver 830 is operatively coupled with the processor 810, and transmits and/or receives a radio signal.

A UE 900 includes a processor 910, a memory 920 and a transceiver 930. The processor 910 may be configured to implement proposed functions, procedures and/or methods described in this description. Layers of the radio interface protocol may be implemented in the processor 910. The memory 920 is operatively coupled with the processor 910 and stores a variety of information to operate the processor 910. The transceiver 930 is operatively coupled with the processor 910, and transmits and/or receives a radio signal.

The processors 810, 910 may include application-specific integrated circuit (ASIC), other chipset, logic circuit and/or data processing device. The memories 820, 920 may include read-only memory (ROM), random access memory (RAM), flash memory, memory card, storage medium and/or other storage device. The transceivers 830, 930 may include baseband circuitry to process radio frequency signals. When the embodiments are implemented in software, the techniques described herein can be implemented with modules (e.g., procedures, functions, and so on) that perform the functions described herein. The modules can be stored in memories 820, 920 and executed by processors 810, 910. The memories 820, 920 can be implemented within the processors 810, 910 or external to the processors 810, 910 in which case those can be communicatively coupled to the processors 810, 910 via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

What is claimed is:

1. A method for performing a handover procedure from a source cell to a target cell by a user equipment (UE) in a wireless communication system, the method comprising:
receiving a configuration indicating that a random access procedure towards a target cell is not to be performed from a network; and
determining at least one of transmission power or timing advance (TA) for the target cell.

2. The method of claim 1, wherein the transmission power for the target is determined as the same transmission power used for the source cell.

3. The method of claim 1, wherein the transmission power for the target cell is determined by using an accumulated transmit power command (TPC) power used for the source cell.

4. The method of claim 1, wherein the transmission power for the target cell is determined by using an offset from a transmission power used for the source cell.

5. The method of claim 1, wherein the transmission power for the target cell is determined based on measurement.

6. The method of claim 1, wherein the TA for the target cell is determined as 0.

7. The method of claim 1, wherein the TA for the target cell is determined as the same TA used for the source cell.

8. The method of claim 1, further comprising receiving an uplink (UL) grant for transmission to the target cell from the target via the source cell.

9. The method of claim 8, wherein the transmission to the target cell corresponds to a message 3 in the random access procedure.

10. The method of claim 9, wherein a message format used for the message 3 is reused.

11. The method of claim 9, wherein the power for the UL grant is determined based on power control for the message 3.

12. A user equipment (UE) in a wireless communication system, the UE comprising:
a memory;
a transceiver; and
a processor, coupled to the memory and the transceiver, that:
controls the transceiver to receive a configuration indicating that a random access procedure towards a target cell is not to be performed from a network, and
determines at least one of transmission power or timing advance (TA) for the target cell.
